(19) United States
(12) Patent Application Publication
(10) Pub. No.: US 2021/0201122 A1
(43) Pub. Date: Jul. 1, 2021

(54) DATA PROCESSING METHODS, APPARATUSES, DEVICES, STORAGE MEDIA AND PROGRAM PRODUCTS

(71) Applicant: Beijing Sensetime Technology Development Co., Ltd., Beijing (CN)

(72) Inventors: Tao YANG, Beijing (CN); Qingzheng LI, Beijing (CN)

(21) Appl. No.: 17/139,553

(22) Filed: Dec. 31, 2020

Related U.S. Application Data
(63) Continuation of application No. PCT/CN2020/103118, filed on Jul. 20, 2020.

(30) Foreign Application Priority Data
Dec. 27, 2019 (CN) 201911379755.6

(51) Int. Cl. G06N 3/063

(52) U.S. Cl. CPC G06N 3/063

(57) ABSTRACT

The present application provides a data processing method, apparatus, device, a storage medium, and a computer program product. The method includes: obtaining to-be-processed data input to a first calculating unit in a plurality of calculating units, wherein the to-be-processed data includes data of a first bit width; obtaining a processing parameter of the first calculating unit, wherein the processing parameter includes a parameter of a second bit width; and obtaining an output result of the first calculating unit based on the to-be-processed data and the processing parameter, wherein a bit width of to-be-processed data input to a second calculating unit in the plurality of calculating units is different from a bit width of the to-be-processed data input to the first calculating unit, and/or a bit width of a processing parameter input to the second calculating unit is different from a bit width of the processing parameter input to the first calculating unit.

### CROSS REFERENCE TO RELATED APPLICATIONS

This application is a continuation application of International Patent Application No. PCT/CN2020/103118 filed on Jul. 20, 2020, which is based on and claims priority to and benefit of Chinese Patent Application No. 201911379755.6 filed on Dec. 27, 2019. The content of all of the above-identified applications is incorporated herein by reference in their entirety.

### TECHNICAL FIELD

Examples of the present application relate to the field of deep learning technology, and in particular, to data processing methods, apparatuses, devices, storage media and program products.

### BACKGROUND

At present, deep learning is widely used to solve high-level abstract cognitive problems. In the high-level abstract cognitive problems, as deep learning problems become more and more abstract and complex, complexities regarding calculation and data of deep learning increase. However, the deep learning calculation cannot be separated from deep learning network. Accordingly, deep learning network scale needs to be enlarged.

Generally, deep learning calculation tasks may be divided into two types of expressions: on a general-purpose processor, the tasks are usually presented in the form of software codes, and are called software tasks; on a special-purpose hardware circuit, the tasks give full play to a rapid characteristic inherent to hardware to replace software tasks, and are called hardware tasks. Common special-purpose hardware includes an Application Specific Integrated Circuit (ASIC), a Field-Programmable Gate Array (FPGA) and a Graphics Processing Unit (GPU). The FPGA is suitable for different functions and has high flexibility.

When implementing the deep learning network, data accuracy should be considered, for example, what bit width and what data format are used to represent data in each layer of a neural network. The larger the bit width is, the higher the data precision of deep learning models. However, the calculation speed will decrease. If the bit width is smaller, the data precision of the deep learning network will decrease although the calculation speed increases.

### SUMMARY

The examples of the present application provide data processing methods, apparatuses, devices, storage media and program products.

In a first aspect, an example of the present application provides a data processing method, including: obtaining to-be-processed data input to a first calculating unit in a plurality of calculating units, wherein the to-be-processed data includes data of a first bit width; obtaining a processing parameter of the first calculating unit, wherein the processing parameter includes a parameter of a second bit width; and obtaining an output result of the first calculating unit based on the to-be-processed data and the processing parameter, wherein a bit width of to-be-processed data input to a second calculating unit in the plurality of calculating units is different from a bit width of the to-be-processed data input to the first calculating unit, and/or a bit width of a processing parameter input to the second calculating unit is different from a bit width of the processing parameter input to the first calculating unit.

In a second aspect, an example of the present application provides a data processing apparatus, including: a first obtaining module configured to obtain to-be-processed data input to a first calculating unit in a plurality of calculating units, wherein the to-be-processed data includes data of a first bit width; a second obtaining module configured to obtain a processing parameter of the first calculating unit, wherein the processing parameter includes a parameter of a second bit width; and a processing module configured to obtain an output result of the first calculating unit based on the to-be-processed data and the processing parameter, wherein a bit width of to-be-processed data input to a second calculating unit in the plurality of calculating units is different from a bit width of the to-be-processed data input to the first calculating unit, and/or a bit width of a processing parameter input to the second calculating unit is different from a bit width of the processing parameter input to the first calculating unit.

In a third aspect, an example of the present application provides a data processing device, including: a processor; and a memory for storing a processor executable program, wherein the program is executed by the processor to cause the processor to implement the method according to the first aspect.

In a fourth aspect, an example of the present application provides a computer-readable storage medium having a computer program stored thereon, wherein the computer program is executed by a processor to cause the processor to implement the method according to the first aspect.

In a fifth aspect, an example of the present application provides a computer program product including machine executable instructions, wherein the machine executable instructions are read and executed by a computer to cause the computer to implement the method according to the first aspect.

According to the data processing method, apparatus, device, and the storage medium provided by the examples of the present application, after obtaining to-be-processed data input to a first calculating unit in a plurality of calculating units and a processing parameter of the first calculating unit, wherein the to-be-processed data includes data of a first bit width and the processing parameter includes a parameter of a second bit width, an output result of the first calculating unit is obtained based on the to-be-processed data and the processing parameter. A bit width of to-be-processed data input to a second calculating unit in the plurality of calculating units is different from a bit width of the to-be-processed data input to the first calculating unit, and/or a bit width of a processing parameter input to the second calculating unit is different from a bit width of the processing parameter input to the first calculating unit.

Since the bit width of the to-be-processed data input to the second calculating unit in the plurality of calculating units is different from the bit width of the to-be-processed data input to the first calculating unit, and/or the bit width of the processing parameter input to the second calculating unit is different from the bit width of the processing parameter input to the first calculating unit, it may support to-be-processed data of different bit widths. Compared with the case that the neural network layer supports to-be-processed data of a single bit width, the technical solutions provided in the examples may support to-be-processed data of different bit widths. Furthermore, considering that the smaller the bit width is, the higher the calculation speed is, in a case of selecting a processing parameter and/or to-be-processed data of a smaller bit width, the calculation speed of the accelerator may be increased. It thus can be known that the data processing method according to the examples of the present application can support processing data of various bit widths, and improve the data processing speed.

### BRIEF DESCRIPTION OF DRAWINGS

FIG. 1 is a schematic diagram illustrating a data processing system according to an example of the present application.

FIG. 2 is a flowchart illustrating a data processing method according to an example of the present application.

FIG. 3 is a flowchart illustrating a data processing method according to another example of the present application.

FIG. 4 is a schematic diagram illustrating a data structure of read data according to an example of the present application.

FIG. 5 is a schematic diagram illustrating a data structure of output data according to an example of the present application.

FIG. 6 is a schematic structural diagram illustrating a data processing apparatus according to an example of the present application.

FIG. 7 is a schematic structural diagram illustrating a data processing device according to an example of the present application.

### DETAILED DESCRIPTION

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

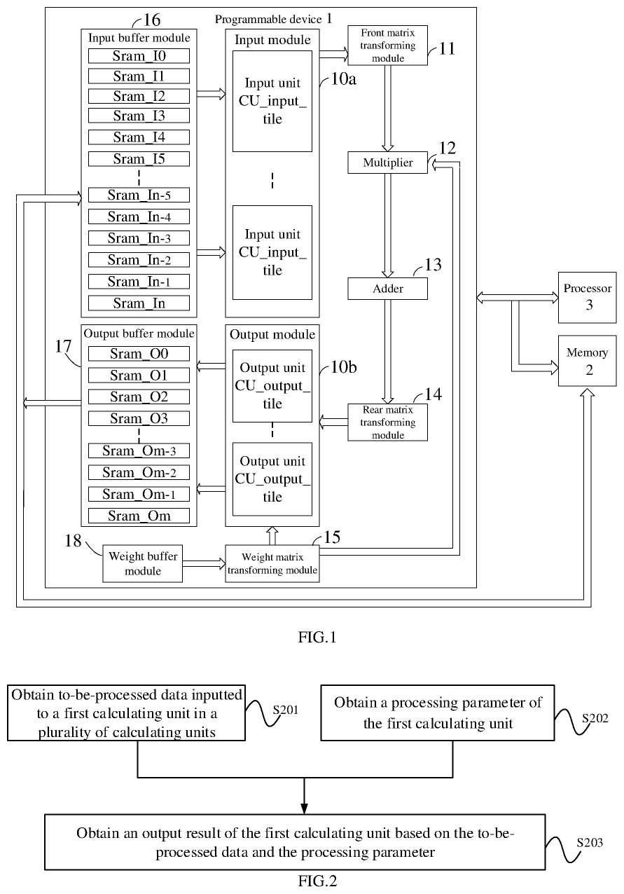

FIG. 1 is a schematic diagram illustrating a data processing system according to an example of the present application. A data processing method according to an example of the present application may be applied to the data processing system shown in FIG. 1. As shown in FIG. 1, the data processing system includes: a programmable device 1, a memory 2 and a processor 3. The programmable device 1 is connected to the memory 2 and the processor 3 respectively. The memory 2 is also connected to the processor 3.

In some embodiments, the programmable device 1 includes a Field-Programmable Gate Array (FPGA). The memory 2 includes a Double Data Rate Synchronous Dynamic Random Access Memory (DDR SDRAM, hereinafter referred to as DDR). The processor 3 includes an ARM processor. The ARM (Advanced RISC Machines) processor refers to a low-power and low-cost RISC (Reduced Instruction Set Computing) microprocessor.

The programmable device 1 includes an accelerator, which may be connected to the memory 2 and the processor 3 respectively through a cross bar. The programmable device 1 may also include other functional modules such as a communication interface and a DMA (Direct Memory Access) controller according to application scenarios, which is not limited in this application.

The programmable device 1 reads data from the memory 2 for processing, and stores a processing result in the memory 2. The programmable device 1 and the memory 2 are connected by a bus. The bus refers to a common communication trunk line by which information is transmitted between various functional components of a computer. The bus is a transmission harness composed of wires. According to different types of information transmitted by the computer, the computer bus may be divided into a data bus, an address bus and a control bus, which are used to transmit data, data addresses and control signals respectively.

The accelerator includes an input module 10a, an output module 10b, a front matrix transforming module 11, a multiplier 12, an adder 13, a rear matrix transforming module 14, a weight matrix transforming module 15, an input buffer module 16, an output buffer module 17 and a weight buffer module 18. The input module 10a, the front matrix transforming module 11, the multiplier 12, the adder 13, the rear matrix transforming module 14 and the output module 10b are connected in sequence. The weight matrix transforming module 15 is connected to the output module 10b and the multiplier 12 respectively. In an example of the present application, the accelerator may include a convolutional neural network CNN accelerator. The DDR, the input buffer module 16 and the input module 10a are connected in sequence. The DDR stores to-be-processed data, for example, feature map data. The output module 10b is connected to the output buffer module 17 and the DDR in sequence. The weight matrix transforming module 15 is also connected to the weight buffer module 18.

The input buffer module 16 reads the to-be-processed data from the DDR and buffers the to-be-processed data. The weight matrix transforming module 15 reads a weight parameter from the weight buffer module 18 and processes the weight parameter. The processed weight parameter is sent to the multiplier 12. The input module 10a reads the to-be-processed data from the input buffer module 16, and sends it to the front matrix transforming module 11 for processing. Data after matrix transformation is sent to the multiplier 12. The multiplier 12 operates the data after matrix transformation according to the weight parameter to obtain a first output result. The first output result is sent to the adder 13 for processing to obtain a second output result. The second output result is sent to the rear matrix transforming module 14 for processing to obtain an output result. The output result is output in parallel to the output buffer module 17 by the output module 10b, and is finally sent to the DDR by the output buffer module 17 for storage. In this way, a calculation process of the to-be-processed data is completed.

The technical solutions of the present application and how the technical solutions of the present application solve the above-described technical problems will be described in detail below with specific examples. The following specific examples may be combined with each other, and the same or similar concepts or processes may not be repeated in some examples. The examples of the present application will be described below in conjunction with the drawings.

FIG. 2 is a flowchart illustrating a data processing method according to an example of the present application. The data processing method according to the example of the present application includes the following steps.

At step 201, to-be-processed data input to a first calculating unit in a plurality of calculating units is obtained.

In this example, the plurality of calculating units may be calculating units of an input layer, hidden layers and/or an output layer of a neural network. The first calculating unit may include one or more calculating units. In the examples of the present application, the technical solutions proposed by the present application are explained by taking the first calculating unit that includes one calculating unit as an example. For the case that the first calculating unit includes a plurality of calculating units, each first calculating unit may use the same or similar implementation manners to complete data processing, which will not be repeated here.

In an embodiment, the first calculating unit may include the input module 10a, the output module 10b, the front matrix transforming module 11, the multiplier 12, the adder 13, the rear matrix transforming module 14 and the weight matrix transforming module 15 as shown in FIG. 1. In another embodiment, the first calculating unit may include the front matrix transforming module 11, the multiplier 12, the adder 13, the rear matrix transforming module 14 and the weight matrix transforming module 15 as shown in FIG. 1.

For the neural network, each layer of the neural network may include the input module 10a, the output module 10b, the front matrix transforming module 11, the multiplier 12, the adder 13, the rear matrix transforming module 14 and the weight matrix transforming module 15 as shown in FIG. 1. Since the calculation process of neural network layers is performed sequentially, the neural network layers may share one input buffer module 16 and one output buffer module 17. In a case that a current layer of the neural network, for example, the first calculating unit, needs to perform an operation, to-be-processed data required by the current layer of the neural network may be obtained from the DDR and input into the input buffer module 16 for buffering, and a processing parameter required by the current layer of the neural network is buffered in the weight buffer module 18.

Illustratively, as shown in FIG. 1, the input module 10a may read the to-be-processed data from the input buffer module 16.

The to-be-processed data in this example includes data whose bit width is a first bit width. The first bit width may include one or more of 4 bits, 8 bits and 32 bits.

At step 202, a processing parameter of the first calculating unit is obtained.

The processing parameter in this example includes a parameter whose bit width is a second bit width, which is a parameter used to participate in convolution operation of the neural network, for example, a weight parameter of a convolution kernel. The second bit width is similar to the first bit width, and may include one or more of 4 bits, 8 bits and 32 bits.

For example, as shown in FIG. 1, the weight matrix transforming module 15 reads the processing parameter from the weight buffer module 18.

Illustratively, in a case that the to-be-processed data and the processing parameter are respectively input data and a weight parameter participating in the convolution operation, the to-be-processed data and the processing parameter are respectively expressed in a matrix form. The bit width of the to-be-processed data is 4 bits, and the bit width of the processing parameter is 8 bits, representing that each data in a matrix corresponding to the to-be-processed data is 4-bit data, and each data in a matrix corresponding to the processing parameter is 8-bit data.

At step 203, an output result of the first calculating unit is obtained based on the to-be-processed data and the processing parameter.

A bit width of to-be-processed data input to a second calculating unit in the plurality of calculating units is different from a bit width of the to-be-processed data input to the first calculating unit, and/or a bit width of a processing parameter input to the second calculating unit is different from a bit width of the processing parameter input to the first calculating unit.

For the second calculating unit, similar to the first calculating unit, the to-be-processed data and the processing parameter of the second calculating unit may be obtained, and then an output result of the second calculating unit is obtained based on the to-be-processed data and the processing parameter of the second calculating unit. For the specific implementation method, please refer to the related description of the first calculating unit, which will not be repeated here.

In this example, the first calculating unit and the second calculating unit may be understood as different neural network layers in the same neural network architecture. In an implementation, neural network layers corresponding to the first calculating unit and the second calculating unit respectively may be adjacent or non-adjacent neural network layers, which are not limited here. That is to say, the bit width of to-be-processed data required by different neural network layers may be different, and the bit width of processing parameters required thereby may also be different.

The to-be-processed data may include a fixed-point number and/or a floating-point number. Similarly, the processing parameter may also include a fixed-point number and/or a floating-point number. The fixed-point number may include 4-bit and 8-bit wide data. The floating-point number may include 32-bit wide data. The fixed-point number refers to a number in which the position of a decimal point is fixed, and usually includes a fixed-point integer and a fixed-point decimal or a fixed-point fraction. After making a choice for the position of the decimal point, all numbers in an operation may be unified into fixed-point integers or fixed-point decimals, and the position of the decimal point is no longer considered in the operation. The floating-point number refers to a number in which the position of a decimal point is not fixed, and is expressed by an exponent and a mantissa. Usually, the mantissa is a pure decimal, and the exponent is an integer. Both the mantissa and the exponent are signed numbers. The sign of the mantissa represents the plus and minus of a number. The sign of the exponent represents the actual position of a decimal point.

For this application, the bit width of data that can be processed by all neural network layers may have at least the following five embodiments. Data of different bit widths that can be processed in the present application is explained below by taking the to-be-processed data and the processing parameter as an example.

In an embodiment, the bit width of the to-be-processed data is 8 bits, and the bit width of the processing parameter is 4 bits. In another embodiment, the bit width of the to-be-processed data is 4 bits, and the bit width of the processing parameter is 8 bits. In yet another embodiment, the bit width of the to-be-processed data is 8 bits, and the bit width of the processing parameter is 8 bits. In still another embodiment, the bit width of the to-be-processed data is 4 bits, and the bit width of the processing parameter is 4 bits. In further another embodiment, the bit width of the to-be-processed data is 32 bits, and the bit width of the processing parameter is 32 bits.

Therefore, the technical solutions provided by the examples of the present application can support floating-point and fixed-point operations. There may include one type of floating-point operations, specifically, operations between to-be-processed data and processing parameter whose bit widths both are 32 bits. There may include four types of fixed-point operations, specifically, operations between to-be-processed data and processing parameter whose bit widths both are 4 bits, operations between to-be-processed data and processing parameter whose bit widths both are 8 bits, operations between to-be-processed data whose bit width is 4 bits and processing parameter whose bit width is 8 bits, and operations between to-be-processed data whose bit width is 8 bits and processing parameter whose bit width is 4 bits.

In this way, the data processing method according to the example of the present application can support processing data of various bit widths, thereby effectively balancing dual requirements for processing accuracy and processing speed, and improving data processing speed in a case that it is ensured that the bit width meets conditions.

In some embodiments, obtaining the output result of the first calculating unit based on the to-be-processed data and the processing parameter includes: obtaining the output result of the first calculating unit by performing a convolution operation based on the to-be-processed data and the processing parameter.

In this example, after obtaining to-be-processed data input to a first calculating unit in a plurality of calculating units and a processing parameter of the first calculating unit, wherein the to-be-processed data includes data of a first bit width and the processing parameter includes a parameter of a second bit width, an output result of the first calculating unit is obtained based on the to-be-processed data and the processing parameter. A bit width of to-be-processed data input to a second calculating unit in the plurality of calculating units is different from a bit width of the to-be-processed data input to the first calculating unit, and/or a bit width of a processing parameter input to the second calculating unit is different from a bit width of the processing parameter input to the first calculating unit. Therefore, it may support to-be-processed data of different bit widths. Compared with the case that the neural network layer supports to-be-processed data of a single bit width, the technical solutions provided in the examples may support to-be-processed data of different bit widths. Furthermore, considering that the smaller the bit width is, the higher the calculation speed is, in a case of selecting a processing parameter and/or to-be-processed data of a smaller bit width, the calculation speed of the accelerator may be increased. It thus can be known that the data processing method according to the examples of the present application can support processing data of various bit widths, and improve the data processing speed.

In some embodiments, obtaining the to-be-processed data input to the first calculating unit in the plurality of calculating units includes: obtaining first configuration information of the first calculating unit, wherein the first configuration information includes the first bit width to indicate that the to-be-processed data input to the first calculating unit is of the first bit width, and at least two calculating units in the plurality of calculating units use different first bit widths; and obtaining, based on the first bit width, to-be-processed data whose bit width is the first bit width.

A neural network layer, before performing an operation, will configure, that is, preset, the bit width of data required by the neural network layer. The first configuration information may be represented by 0, 1 and 2. If the first configuration information is 0, it may be indicated that the bit width of data required by the neural network layer is 8 bits. If the first configuration information is 1, it may be indicated that the bit width of data required by the neural network layer is 4 bits. If the first configuration information is 2, it may be indicated that the bit width of data required by the neural network layer is 32 bits.

In some embodiments, obtaining the processing parameter of the first calculating unit includes: obtaining second configuration information of the first calculating unit, wherein the second configuration information includes the second bit width to indicate that the processing parameter input to the first calculating unit is of the second bit width, and at least two calculating units in the plurality of calculating units use different second bit widths; and obtaining, based on the second bit width, a processing parameter whose bit width is the second bit width.

Similarly, a neural network layer, before performing an operation, will configure, that is, preset, the bit width of a processing parameter required by the neural network layer. The second configuration information may be represented by 0, 1 and 2. If the second configuration information is 0, it may be indicated that the bit width of the processing parameter required by the neural network layer is 8 bits. If the second configuration information is 1, it may be indicated that the bit width of the processing parameter required by the neural network layer is 4 bits. If the second configuration information is 2, it may be indicated that the bit width of the processing parameter required by the neural network layer is 32 bits.

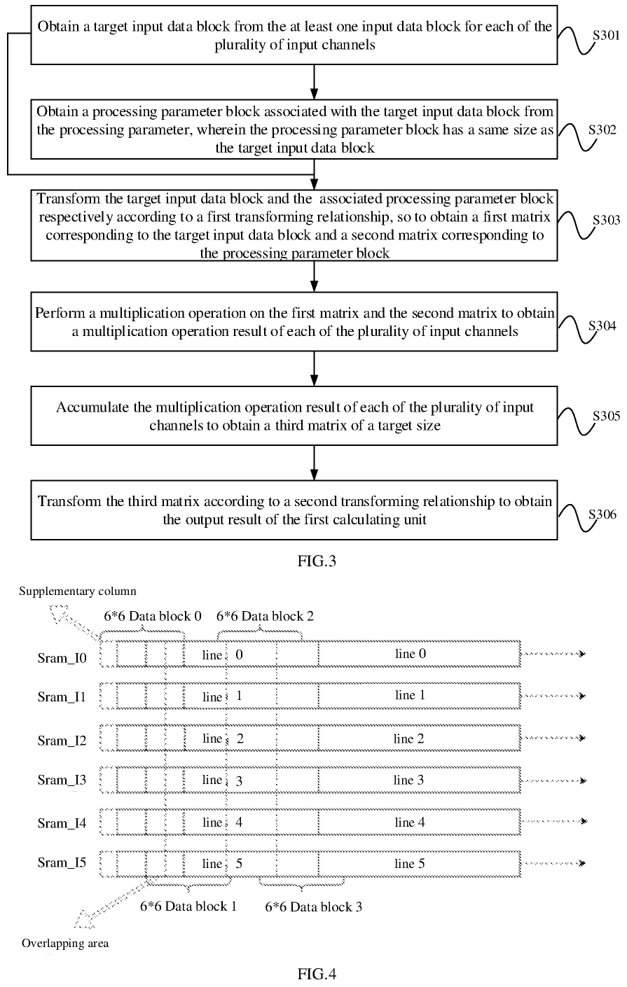

FIG. 3 is a flowchart illustrating a data processing method according to another example of the present application. As shown in FIG. 3, the data processing method according to this example includes the following steps.

At step 301, for each of the plurality of input channels, a target input data block is obtained from at least one input data block.

The to-be-processed data includes input data from the plurality of input channels, and the input data includes the at least one input data block.

In this example, the plurality of input channels includes R (Red), G (Green) and B (Blue) channels, and the to-be-processed data includes input data from the R, G and B channels. In the process of obtaining the input data from each input channel, the input data is obtained according to the input data block. For example, if the target input data block has a size of n*n, a data block having a size of n*n is obtained, wherein n is an integer greater than 1. As an example, the target input data block having a size of n*n may be n*n pixel points in a feature map of the current layer of the neural network.

At step 302, a processing parameter block associated with the target input data block is obtained from the processing parameter. The processing parameter block has a same size as the target input data block.

For example, if the size of the target input data block is 6*6, the size of the processing parameter block is 6*6.

At step 303, the target input data block and the associated processing parameter block are transformed respectively according to a first transforming relationship, so to obtain a first matrix corresponding to the target input data block and a second matrix corresponding to the processing parameter block.

In some embodiments, the first transforming relationship includes a front matrix transformation. In this example, the front matrix transformation is performed on the target input data block having a size of n*n to obtain the first matrix having a size of n*n, and the front matrix transformation is performed on the processing parameter block having a size of n*n to obtain the second matrix having a size of n*n.

At step 304, a multiplication operation is performed on the first matrix and the second matrix to obtain a multiplication operation result of each of the plurality of input channels.

Illustratively, in this step, the first matrix and the second matrix are multiplied to obtain the multiplication operation result of each input channel such as the R, G or B channel. For example, the target input data block having a size of 6*6 and the processing parameter block having a size of 6*6 are multiplied. According to a Winograd algorithm, a multiplication operation result having a size of 4*4 may be obtained.

At step 305, the multiplication operation result of each of the plurality of input channels is accumulated to obtain a third matrix of a target size.

Illustratively, in this step, the multiplication operation results of the R, G and B channels are accumulated to obtain the third matrix of the target size. For example, the multiplication operation results of the R, G and B channels are accumulated to obtain the third matrix of a size of 4*4.

At step 306, the third matrix is transformed according to a second transforming relationship to obtain the output result of the first calculating unit.

In some embodiments, the second transforming relationship includes rear matrix transformation. In this example, the rear matrix transformation is performed on the third matrix to obtain the output result. The rear matrix transformation is performed on the third matrix to obtain the output result of the first calculating unit. For example, in a case that the to-be-processed data is a feature map, an operation result of the feature map is obtained.

The implementation process of this example will be described through a specific embodiment in detail below with reference to FIG. 1. In this example, the Winograd algorithm may be implemented on the data processing system shown in FIG. 1. The principle of the Winograd algorithm is as follows:

Y=A^{T}{[GgG^{T}]⊗[B^{T}dB]}A

wherein, g represents a convolution kernel, for example, the processing parameter of the first calculating unit; d represents a data block that participates in a Winograd calculation each time, that is, the target input data block, for example, at least part of the to-be-processed data in the first calculating unit; B^{T}dB represents that the front matrix transformation is performed on the target input data block d, and a result corresponding to the B^{T}dB is the first matrix; GgG^{T} represents that the front matrix transformation is performed on the convolution kernel g, and a result corresponding to the GgG^{T} is the second matrix; ┌GgG^{T}┐⊗┌B^{T}dB┐ represents that a dot product, i.e., a multiplication operation, is performed on the two results of the front matrix transformation, i.e., the first matrix and the second matrix; A^{T}{┌GgG^{T}┐⊗┌B^{T}dB┐}A represents that data from each channel in a dot product result is accumulated to obtain the third matrix, and the rear matrix transformation is performed on the third matrix to obtain a final output result Y.

In some embodiments, the Winograd algorithm is applied to the data processing system shown in FIG. 1. Taking the first calculating unit as an example, the specific implementation process includes: inputting the target input data block having a size of 6*6 into the front matrix transforming module 11 to perform the front matrix transformation, so to obtain the first matrix having a size of 6*6; performing the front matrix transformation on the processing parameter by the weight matrix transforming module 15, so to obtain the second matrix having a size of 6*6; inputting the first matrix and the second matrix to the multiplier 12 respectively to perform a dot product operation; inputting a dot product operation result to the adder 13; accumulating data from each channel; inputting an accumulation result to the rear matrix transforming module 14 to perform the rear matrix transformation, so to obtain the output result of the first calculating unit.

In this example, multiplication operation usually has a slower speed than addition operation in a computer. Therefore, the addition operation is used instead of partial multiplication operation. By reducing the number of multiplications and increasing a small number of additions, the data processing speed may be improved.

Through this design, according to an example of the present application, target input data blocks of 2 types of fixed-point numbers and processing parameter blocks of 2 types of fixed-point numbers may be combined to obtain 4 combinations, and then by adding the operation of 1 type of floating-point numbers, convolution operations of a total of 5 types of mixing precision may be realized. Since the Winograd algorithm may reduce the number of multiplications, the data processing speed may be improved. Therefore, according to the example of the present application, both the operation speed and operation precision may be taken into consideration at the same time. That is, not only the operation speed may be improved, but also the operation of mixing precision may be realized.

It should be noted that the Winograd algorithm is only a possible implementation manner adopted in the example of the present application. In an actual application process, other implementation manners with functions similar to or the same as the Winograd algorithm may also be used, which is not limited here.

In some embodiments, obtaining the to-be-processed data input to the first calculating unit in the plurality of calculating units includes: inputting the input data from the plurality of input channels in parallel into a plurality of first storage areas, wherein a number of the first storage areas is the same as a number of the input channels, and input data from different input channels is input into different first storage areas. The first storage area in this example is a storage area in the input buffer module 16.

In some embodiments, each of the plurality of first storage areas includes a plurality of input line buffers, a number of lines of the input data is the same as a number of columns of the input data, a number of lines of the target input data block is the same as a number of input line buffers in a corresponding first storage area, and for each of the plurality of input channels, obtaining the target input data block from the at least one input data block includes: reading data in parallel from a plurality of input line buffers of each input channel to obtain the target input data block.

In some embodiments, two adjacent input data blocks in the input data have overlapping data therebetween.

Please continue to refer to FIG. 1. The plurality of first storage areas may be the input buffer module 16. The input buffer module 16 includes a plurality of input line buffers such as Sram_I0, Sram_I1, Sram_I2, . . . and Sram_In. One first storage area is a plurality of input line buffers in the input buffer module 16 such as Sram_I0, Sram_I1, Sram_I2, . . . and Sram_I5. The input buffer module 16 includes a plurality of input line buffers. The input module 10a includes a plurality of input units CU_input_tile. Each input unit corresponds to a first preset number of input line buffers. The first preset number corresponds to the number of lines of the target input data block. For example, if the target input data block has a size of 6*6, the first preset number is 6.

The input calculation parallelism IPX of the input module 10a is 8. For example, 8 parallel input units CU_input_tile may be provided in the input module 10a.

In some embodiments, each input unit CU_input_tile reads input data from one input channel in a plurality of input line buffers. For example, if data read by the input buffer module 16 from the DDR includes input data from the R, G and B channels, input data from each of the R, G and B channels are respectively stored in the first preset number of input line buffers in the input buffer module 16.

FIG. 4 is a schematic diagram illustrating an input module that obtains data according to an example of the present application.

As shown in FIG. 4, the input module reads a first target input data block and a second target input data block from the input buffer module. The second target input data block is adjacent to the first target input data block. The sequence for the second target input data block to be read is behind the sequence for the first target input data block to be read. There is overlapping data between the first target input data block and the second target input data block.

In some embodiments, there being the overlapping data between the first target input data block and the second target input data block refers to that a first column of data in the second target input data block is a second-to-last column of data in the first target input data block.

In some embodiments, in a case that the first target input data block is a read first target input data block, the method according to this example further includes: for input line buffers of each input channel, adding supplementary data before a start position of data read from each input line buffer to form the first target input data block.

Illustratively, in a case that the input line buffer is a high-speed buffer Sram, as shown in FIG. 4, it can be seen that data read from the high-speed buffer Sram is 6 parallel lines of data: Sram_I0, Sram_I1, Sram_I2, Sram_I3, Sram_I4 and Sram_I5. That is, each input unit reads data in parallel from the Sram_I0, Sram_I1, Sram_I2, Sram_I3, Sram_I4 and Sram_I5. According to this example, a supplementary column is added to a start column when the data is read from the high-speed buffer Sram. For example, a column of data being 0 is added to each of start columns of Sram_I0, Sram_I1, Sram_I2, Sram_I3, Sram_I4 and Sram_I5. The added data and subsequent 5 columns of normal data form a 6×6 data block 0. In addition, there is an overlapping area between every two 6×6 data blocks. For example, there is an overlapping area between a data block 0 and a data block 1. Similarly, there is an overlapping area between a data block 1 and a data block 2. In other words, there is overlapping data between the first target input data block and the second target input data block. Because according to the Winograd algorithm, the supplementary column of data is added to the start column when a window is sliding, and a part of data will be reused. Therefore, in this example, when data is read, an overlapping area is provided between two read data blocks and the supplementary column is added to the start column, which may implement the Winograd algorithm on a hardware structure according to this example.

In another example, if the first configuration information and the second configuration information of the neural network layer are 4 bits and 8 bits respectively, in the process of reading data from the high-speed buffer Sram, the read data in the target input data block is 4-bit wide target input data, and in the process of reading processing parameters from the weight buffer module, the read data in the processing parameter block is 8-bit wide processing parameters.

In some embodiments, the output result of the first calculating unit includes output results of a plurality of output channels, and after transforming the third matrix according to the second transforming relationship to obtain the output result of the first calculating unit, the method according to this example further includes: outputting the output results of the plurality of output channels in parallel.

In some embodiments, outputting the output results of the plurality of output channels in parallel includes: in a case of outputting operation results of the plurality of output channels at a time, adding biases respectively to the output results of the plurality of output channels and outputting the output results added with the biases. The biases may be bias parameters in the convolutional layer of the neural network.

In some embodiments, the method according to this example further includes: inputting the output results of the plurality of output channels in parallel into a plurality of second storage areas, wherein a number of the second storage areas is the same as a number of the output channels, and output results of different output channels are input into different second storage areas.

In some embodiments, each of the second storage areas includes a plurality of output line buffers; the output results include a plurality of lines of output data and a plurality of columns of output data; a target output data block is obtained by reading data in parallel from the plurality of output line buffers in a bus-aligned manner and is written into a memory, wherein a number of lines of the target output data block is the same as a number of columns of the target output data block. The memory in this example may be the DDR.

Please continue to refer to FIG. 1. The plurality of second storage areas may be the output buffer module 17. The output buffer module 17 includes a plurality of output line buffers such as Sram_O0, Sram_O1, Sram_O2, . . . and Sram_Om. One second storage area is a plurality of output line buffers in the output buffer module 17 such as Sram_O0, Sram_O1, Sram_O2 and Sram_O3. The output module 10b includes a plurality of output units CU_output_tile. Each output unit corresponds to a second preset number of output line buffers. The second preset number corresponds to the number of lines of the target output data block. For example, if the target output data block has a size of 4*4, the second preset number is 4.

The output calculation parallelism OPX of the output module 10b is 4. For example, 4 parallel output units CU_output_tiles may be provided in the output module 10b.

Illustratively, in a case that the output line buffer is a high-speed buffer Sram, as shown in FIG. 5, a plurality of lines of output results may be written respectively into four output line buffers: Sram_O0, Sram_O1, Sram_O2 and Sram_O3. That is to say, each output unit buffers data in parallel to Sram_Oi, Sram_Oi+1, Sram_Oi+2 and Sram_Oi+3. The internal storage of the output buffer module needs to be written in a data bus-aligned manner. Similarly, there are three data form aligned manners (4 bits, 8 bits and 32 bits) according to configuration, and data is written into the DDR in the order of line0, line1, line2 and line3 as shown in FIG. 5.

In some embodiments, before performing the multiplication operation on the first matrix and the second matrix, the method according to this example further includes: obtaining third configuration information; and in a case that the third configuration information indicates that the first calculating unit supports a floating-point operation, processing floating-point data in the to-be-processed data. In this example, the third configuration information is used to indicate whether the multiplication operation can be performed on the floating-point data. If the third configuration information indicates that the multiplication operation can be performed on the floating-point data, to-be-processed data in a floating-point type is obtained for processing. If the third configuration information indicates that the multiplication operation cannot be performed on the floating-point data, the to-be-processed data in the floating-point type is not obtained. In an example, the third configuration information may be set for the multiplier 13 in the FPGA to indicate whether the multiplier 13 supports the floating-point operation. If the third configuration information indicates that the multiplier 13 supports the floating-point operation, the to-be-processed data in the floating-point type is obtained for processing. If the third configuration information indicates that the multiplier 13 does not support the floating-point operation, the to-be-processed data in the floating-point type is not obtained. For example, the multiplier 13 may select whether to use a fixed-point multiplier or a floating-point multiplier according to the third configuration information. In this way, the multiplier may be flexibly configured. In the FPGA, resources used by the floating-point multiplier are 4 times resources used by the fixed-point multiplier. In a case that the floating-point multiplier is not configured or not activated, resources consumed by the floating-point operation may be saved, and the data processing speed is improved.

The data processing method according to this example may be applied to scenes such as automatic driving and image processing. The automatic driving scene is taken as an example. In an example, to-be-processed data is an environment image obtained in the process of automatic driving. The environment image needs to be processed via the neural network. During the processing of the environment image, different neural network layers may support to-be-processed data of different bit widths, and the smaller the bit width is, the higher the calculation speed is. Therefore, compared to the case that neural network layers support to-be-processed data of a single bit width, the neural network layers according to this example support the to-be-processed data of different bit widths, which may improve the speed of processing the environment image as far as possible while ensuring the precision of the image. Furthermore, in calculations, multiplication is usually slower than addition. Therefore, using addition operation instead of partial multiplication operation may reduce the number of multiplications, increase a small number of additions, and speed up the processing of the environment image. After the speed of processing the environment image is improved, performing subsequent driving decision-making, path planning or the like by using a result of processing the environment image may also speed up the process of driving decision-making or path planning.

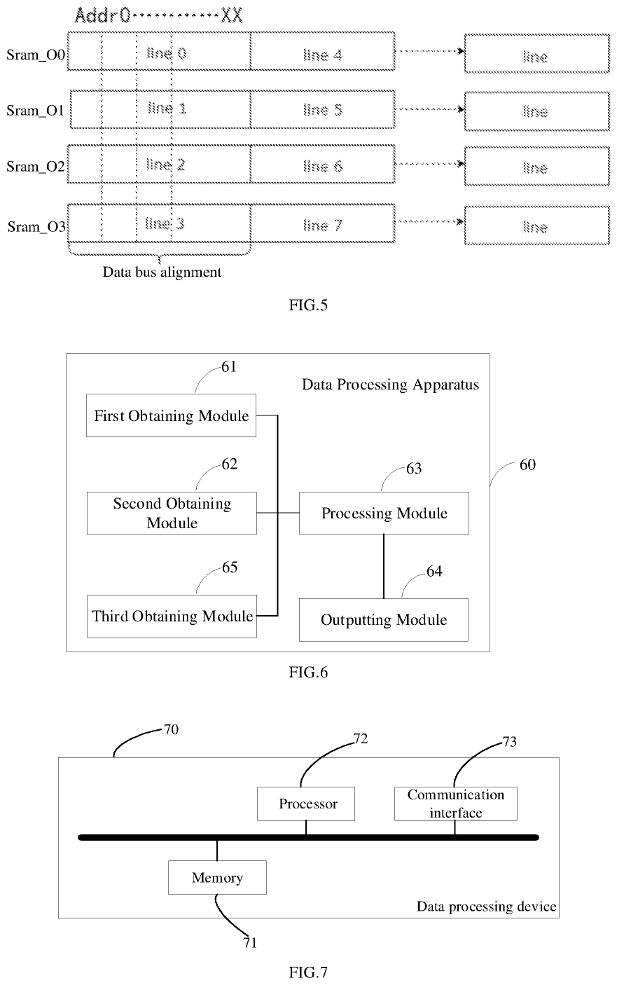

FIG. 6 is a schematic structural diagram illustrating a data processing apparatus according to an example of the present application. The data processing apparatus according to the example of the present application may execute the processing flow provided in the data processing method example. As shown in FIG. 6, a data processing apparatus 60 includes a first obtaining module 61, a second obtaining module 62 and a processing module 63. The first obtaining module 61 is configured to obtain to-be-processed data input to a first calculating unit in a plurality of calculating units, wherein the to-be-processed data includes data of a first bit width. The second obtaining module 62 is configured to obtain a processing parameter of the first calculating unit, wherein the processing parameter includes a parameter of a second bit width. The processing module 63 is configured to obtain an output result of the first calculating unit based on the to-be-processed data and the processing parameter. A bit width of to-be-processed data input to a second calculating unit in the plurality of calculating units is different from a bit width of the to-be-processed data input to the first calculating unit, and/or a bit width of a processing parameter input to the second calculating unit is different from a bit width of the processing parameter input to the first calculating unit.

In some embodiments, when obtaining the to-be-processed data input to the first calculating unit in the plurality of calculating units, the first obtaining module 61 is specifically configured to: obtain first configuration information of the first calculating unit, wherein the first configuration information includes the first bit width to indicate that the to-be-processed data input to the first calculating unit is of the first bit width, and at least two calculating units in the plurality of calculating units use different first bit widths; and obtain, based on the first bit width, to-be-processed data whose bit width is the first bit width.

In some embodiments, when obtaining the processing parameter of the first calculating unit, the second obtaining module 62 is specifically configured to: obtain second configuration information of the first calculating unit, wherein the second configuration information includes the second bit width to indicate that the processing parameter input to the first calculating unit is of the second bit width, and at least two calculating units in the plurality of calculating units use different second bit widths; and obtain, based on the second bit width, a processing parameter whose bit width is the second bit width.

In some embodiments, the to-be-processed data includes input data from a plurality of input channels, and the input data includes at least one input data block. When obtaining the output result of the first calculating unit based on the to-be-processed data and the processing parameter, the processing module 63 is specifically configured to: for each of the plurality of input channels, obtain a target input data block from the at least one input data block; obtain a processing parameter block associated with the target input data block from the processing parameter, wherein the processing parameter block has a same size as the target input data block; transform the target input data block and the associated processing parameter block respectively according to a first transforming relationship, so to obtain a first matrix corresponding to the target input data block and a second matrix corresponding to the processing parameter; perform a multiplication operation on the first matrix and the second matrix to obtain a multiplication operation result of each of the plurality of input channels; accumulate the multiplication operation result of each of the plurality of input channels to obtain a third matrix of a target size; and transform the third matrix according to a second transforming relationship to obtain the output result of the first calculating unit.

In some embodiments, the output result of the first calculating unit includes output results of a plurality of output channels. The apparatus 60 further includes: an outputting module 64 configured to output the output results of the plurality of output channels in parallel.

In some embodiments, when obtaining the to-be-processed data input to the first calculating unit in the plurality of calculating units, the first obtaining module 61 is specifically configured to: input the input data from the plurality of input channels in parallel into a plurality of first storage areas, wherein a number of the first storage areas is the same as a number of the input channels, and input data from different input channels is input into different first storage areas.

In some embodiments, each of the plurality of first storage areas includes a plurality of input line buffers, a number of lines of the input data is the same as a number of columns of the input data, a number of lines of the target input data block is the same as a number of input line buffers in a corresponding first storage area. When obtaining the target input data block from the at least one input data block for each of the plurality of input channels, the processing module 63 is specifically configured to: read data in parallel from a plurality of input line buffers of each input channel to obtain the target input data block.

In some embodiments, two adjacent input data blocks in the input data have overlapping data therebetween.

In some embodiments, when outputting the output results of the plurality of output channels in parallel, the outputting module 64 is specifically configured to: in a case of outputting operation results of the plurality of output channels at a time, adding biases respectively to the output results of the plurality of output channels and outputting the output results added with the biases.

In some embodiments, the outputting module 64 is further configured to input the output results of the plurality of output channels in parallel into a plurality of second storage areas, wherein a number of the second storage areas is the same as a number of the output channels, and output results of different output channels are input into different second storage areas.

In some embodiments, each of the second storage areas includes a plurality of output line buffers. The output results include a plurality of lines of output data and a plurality of columns of output data. The outputting module 64 obtains a target output data block by reading data in parallel from the plurality of output line buffers in a bus-aligned manner and is written into a memory. A number of lines of the target output data block is the same as a number of columns of the target output data block.

In some embodiments, the apparatus 60 further includes: a third obtaining module 65 configured to obtain third configuration information. The processing module 63 is further configured to, in a case that the third configuration information indicates that the first calculating unit supports a floating-point operation, process floating-point data in the to-be-processed data.

The data processing apparatus in the example shown in FIG. 6 may be used to implement the technical solutions in the method examples. Their implementation principles and technical effects are similar, and will not be repeated here.

FIG. 7 is a schematic structural diagram illustrating a data processing device according to an example of the present application. As shown in FIG. 7, the data processing device 70 includes: a memory 71; a processor 72; a computer program; and a communication interface 73, wherein the computer program is stored in the memory 71 and configured to be executed by the processor 72 to implement the technical solutions in the data processing method examples as described above.

The data processing device in the example shown in FIG. 7 may be used to implement the technical solutions in the method examples. Their implementation principles and technical effects are similar, and will not be repeated here.

In addition, an example of the present application provides a computer-readable storage medium having a computer program stored thereon, wherein the computer program is executed by a processor to implement the data processing method in the examples as described above.

In several examples provided in this application, it should be understood that the disclosed apparatus and method may be implemented in other ways. The apparatus examples described above are only schematic. For example, the division of units is only the division of logical functions, and in actual implementation, there may be other division manners, for example, multiple units or components may be combined, or integrated into another system, or some features may be ignored, or not be implemented. In addition, the coupling or direct coupling or communication connection between displayed or discussed components may be through some interfaces, and the indirect coupling or communication connection between apparatuses or units may be electrical, mechanical or in other forms.

The units described as separate components may or may not be physically separated, and the components displayed as units may or may not be physical units, which may be located in one place or may be distributed to multiple network units. Some or all of the units may be selected according to actual needs to achieve the objectives of the present application.

In addition, all functional units in the examples of the present application may be integrated into one processing unit, or each unit may be present alone physically, or two or more units may be integrated into one unit. The integrated unit may be implemented in the form of hardware, or in the form of hardware and software functional units.

The integrated unit implemented in the form of software functional unit may be stored in a computer-readable storage medium. The software functional units are stored in a storage medium, and include several instructions to cause a computer device, which may be a personal computer, a server, a network device, etc., or a processor to perform partial steps in the methods as described in the examples of the present application. The storage medium includes: a USB flash drive, a mobile hard disk drive, a Read-Only Memory (ROM), a Random Access Memory (RAM), a magnetic disk, an optical disk or other medium that can store program codes. The computer storage medium may be a volatile storage medium and/or a non-volatile storage medium.

The above-mentioned examples may be implemented in whole or in part by software, hardware, firmware or any combination thereof, and when being implemented by the software, they may be implemented in the form of a computer program product in whole or in part. The computer program product includes one or more machine executable instructions. When the machine executable instructions are loaded and executed on a computer, procedures or functions according to the examples of the present application are generated in whole or in part. The computer may be a general-purpose computer, a special-purpose computer, a computer network or other programmable apparatuses. Computer instructions may be stored in a computer-readable storage medium, or transmitted from a computer-readable storage medium to another computer-readable storage medium. For example, the computer instructions may be transmitted from a website, computer, trajectory prediction device or data center to another website, computer, trajectory prediction device or data center in a wired manner such as a coaxial cable, an optical fiber and a digital subscriber line (DSL), or in a wireless manner such as infrared, radio and microwave. The computer-readable storage medium may be any available medium that may be accessed by a computer or a data storage device such as a trajectory prediction device and a data center integrated with one or more available media. The available medium may be a magnetic medium such as a floppy disk, a hard disk and a magnetic tape, an optical medium such as a DVD, a semiconductor medium such as a solid state disk (SSD), etc.

Those skilled in the art can clearly understand that for the convenience and conciseness of description, only the division of functional modules is used as an example for illustration. In practical applications, functions may be allocated as needed to be achieved by different functional modules. That is, the internal structure of an apparatus is divided into different functional modules to complete all or part of the functions. For the specific working process of the apparatus described above, reference may be made to corresponding process in the method examples, which is not repeated here.

Finally, it should be noted that the above examples are used only to illustrate the technical solutions of the application, but not to make a limitation thereto. Although the application has been described in detail with reference to the examples, those of ordinary skill in the art should understand that it is still possible to modify the technical solutions described in the examples, or equivalently replace part or all of technical features therein, and these modifications or replacements do not make the essence of corresponding technical solutions depart from the scope of the technical solutions in the examples of this application.

What is claimed is:

1. A data processing method, comprising:
obtaining to-be-processed data input to a first calculating unit in a plurality of calculating units, wherein the to-be-processed data comprises data of a first bit width;
obtaining a processing parameter of the first calculating unit, wherein the processing parameter comprises a parameter of a second bit width; and
obtaining an output result of the first calculating unit based on the to-be-processed data and the processing parameter,
wherein a bit width of to-be-processed data input to a second calculating unit in the plurality of calculating units is different from a bit width of the to-be-processed data input to the first calculating unit, and/or
a bit width of a processing parameter input to the second calculating unit is different from a bit width of the processing parameter input to the first calculating unit.

2. The method according to claim 1, wherein obtaining the to-be-processed data input to the first calculating unit in the plurality of calculating units comprises:
obtaining first configuration information of the first calculating unit, wherein
the first configuration information comprises the first bit width to indicate that the to-be-processed data input to the first calculating unit is of the first bit width, and
at least two calculating units in the plurality of calculating units use different first bit widths; and
obtaining, based on the first bit width, to-be-processed data whose bit width is the first bit width.

3. The method according to claim 1, wherein obtaining the processing parameter of the first calculating unit comprises:
obtaining second configuration information of the first calculating unit, wherein
the second configuration information comprises the second bit width to indicate that the processing parameter input to the first calculating unit is of the second bit width, and
at least two calculating units in the plurality of calculating units use different second bit widths; and
obtaining, based on the second bit width, a processing parameter whose bit width is the second bit width.

4. The method according to claim 1, wherein
the to-be-processed data comprises input data from a plurality of input channels, and the input data comprises at least one input data block, and
obtaining the output result of the first calculating unit based on the to-be-processed data and the processing parameter comprises:
for each input channel of the plurality of input channels,
obtaining a target input data block from the at least one input data block for the input channel;
obtaining a processing parameter block associated with the target input data block from the processing parameter, wherein the processing parameter block has a same size as the target input data block;
transforming the target input data block and the associated processing parameter block respectively according to a first transforming relationship, so to obtain a first matrix corresponding to the target input data block and a second matrix corresponding to the processing parameter block; and
performing a multiplication operation on the first matrix and the second matrix to obtain a multiplication operation result of the input channel;
accumulating the multiplication operation result of each of the plurality of input channels to obtain a third matrix of a target size; and
transforming the third matrix according to a second transforming relationship to obtain the output result of the first calculating unit.

5. The method according to claim 4, wherein
the output result of the first calculating unit comprises output results of a plurality of output channels, and
after transforming the third matrix according to the second transforming relationship to obtain the output result of the first calculating unit, the method further comprises:
outputting the output results of the plurality of output channels in parallel.

6. The method according to claim 4, wherein obtaining the to-be-processed data input to the first calculating unit in the plurality of calculating units comprises:
inputting the input data from the plurality of input channels in parallel into a plurality of first storage areas, wherein
a number of the first storage areas is the same as a number of the input channels, and
input data from different input channels is input into different first storage areas.

7. The method according to claim 6, wherein
each of the plurality of first storage areas comprises a plurality of input line buffers, a number of lines of the input data is the same as a number of columns of the input data, and a number of lines of the target input data block is the same as a number of input line buffers in a corresponding first storage area, and
obtaining the target input data block from the at least one input data block for the input channel comprises:
reading data in parallel from a plurality of input line buffers of the input channel to obtain the target input data block.

8. The method according to claim 6, wherein two adjacent input data blocks in the input data have overlapping data therebetween.

9. The method according to claim 5, wherein outputting the output results of the plurality of output channels in parallel comprises:
in response to outputting operation results of the plurality of output channels at a time, adding biases respectively to the output results of the plurality of output channels and outputting the output results added with the biases.

10. The method according to claim 5, further comprising:
inputting the output results of the plurality of output channels in parallel into a plurality of second storage areas, wherein
a number of the second storage areas is the same as a number of the output channels, and
output results of different output channels are input into different second storage areas.

11. The method according to claim 10, wherein
each of the second storage areas comprises a plurality of output line buffers;
the output results comprise a plurality of line of output data and a plurality of columns of output data; and
a target output data block is obtained by reading data in parallel from the plurality of output line buffers in a bus-aligned manner and is written into a memory, and wherein a number of lines of the target output data block is the same as a number of columns of the target output data block.

12. The method according to claim 4, wherein before performing the multiplication operation on the first matrix and the second matrix, the method further comprises:
obtaining third configuration information; and
in response to that the third configuration information indicates that the first calculating unit supports a floating-point operation, processing floating-point data in the to-be-processed data.

13. The method according to claim 6, wherein before performing the multiplication operation on the first matrix and the second matrix, the method further comprises:
obtaining third configuration information; and
in response to that the third configuration information indicates that the first calculating unit supports a floating-point operation, processing floating-point data in the to-be-processed data.

14. A data processing device, comprising:
a processor; and
a memory for storing a computer readable program,
wherein the computer readable program is executed by the processor to cause the processor to perform operations comprising:
obtaining to-be-processed data input to a first calculating unit in a plurality of calculating units, wherein the to-be-processed data comprises data of a first bit width;
obtaining a processing parameter of the first calculating unit, wherein the processing parameter comprises a parameter of a second bit width; and
obtaining an output result of the first calculating unit based on the to-be-processed data and the processing parameter,
wherein a bit width of to-be-processed data input to a second calculating unit in the plurality of calculating units is different from a bit width of the to-be-processed data input to the first calculating unit, and/or
a bit width of a processing parameter input to the second calculating unit is different from a bit width of the processing parameter input to the first calculating unit.

15. The device according to claim 14, wherein the operations further comprise:
obtaining first configuration information of the first calculating unit, wherein the first configuration information comprises the first bit width to indicate that the to-be-processed data input to the first calculating unit is of the first bit width, and at least two calculating units in the plurality of calculating units use different first bit widths, and
obtaining, based on the first bit width, to-be-processed data whose bit width is the first bit width; and
obtaining second configuration information of the first calculating unit, wherein the second configuration information comprises the second bit width to indicate that the processing parameter input to the first calculating unit is of the second bit width, and at least two calculating units in the plurality of calculating units use different second bit widths, and
obtaining, based on the second bit width, a processing parameter whose bit width is the second bit width.

16. The device according to claim 14, wherein
the to-be-processed data comprises input data from a plurality of input channels, and the input data comprises at least one input data block, and
the operations further comprise:
for each input channel of the plurality of input channels,
obtaining a target input data block from the at least one input data block for the input channel;
obtaining a processing parameter block associated with the target input data block from the processing parameter, wherein the processing parameter block has a same size as the target input data block;
transforming the target input data block and the associated processing parameter block respectively according to a first transforming relationship, so to obtain a first matrix corresponding to the target input data block and a second matrix corresponding to the processing parameter block; and
performing a multiplication operation on the first matrix and the second matrix to obtain a multiplication operation result of the input channel;
accumulating the multiplication operation result of each of the plurality of input channels to obtain a third matrix of a target size; and
transforming the third matrix according to a second transforming relationship to obtain the output result of the first calculating unit.

17. The device according to claim 16, wherein
the output result of the first calculating unit comprises output results of a plurality of output channels, and
the operations further comprise:
outputting the output results of the plurality of output channels in parallel, by: in response to outputting operation results of the plurality of output channels at a time, adding biases respectively to the output results of the plurality of output channels and outputting the output results added with the biases; and
inputting the output results of the plurality of output channels in parallel into a plurality of second storage areas, wherein a number of the second storage areas is the same as a number of the output channels, and output results of different output channels are input into different second storage areas.

18. The device according to claim 16, wherein the operations further comprise:
inputting the input data from the plurality of input channels in parallel into a plurality of first storage areas, wherein a number of the first storage areas is the same as a number of the input channels, and input data from different input channels is input into different first storage areas;
each of the plurality of first storage areas comprises a plurality of input line buffers, a number of lines of the input data is the same as a number of columns of the input data, and a number of lines of the target input data block is the same as a number of input line buffers in a corresponding first storage area; and
reading data in parallel from a plurality of input line buffers of the input channel to obtain the target input data block.

19. The device according to claim 14, wherein the operations further comprise:
obtaining third configuration information; and
in response to that the third configuration information indicates that the first calculating unit supports a floating-point operation, processing floating-point data in the to-be-processed data.

20. A computer-readable storage medium having a computer readable program stored thereon, wherein the computer readable program is executed by a processor to cause the processor to perform operations comprising:
obtaining to-be-processed data input to a first calculating unit in a plurality of calculating units, wherein the to-be-processed data comprises data of a first bit width;
obtaining a processing parameter of the first calculating unit, wherein the processing parameter comprises a parameter of a second bit width; and
obtaining an output result of the first calculating unit based on the to-be-processed data and the processing parameter,
wherein a bit width of to-be-processed data input to a second calculating unit in the plurality of calculating units is different from a bit width of the to-be-processed data input to the first calculating unit, and/or
a bit width of a processing parameter input to the second calculating unit is different from a bit width of the processing parameter input to the first calculating unit.
